(19) United States
(12) Patent Application Publication
(10) Pub. No.: US 2016/0381163 A1
(43) Pub. Date: Dec. 29, 2016

(54) SHARED EXPERIENCE AND MULTI-DEVICE HARDWARE PLATFORM

(71) Applicant: Friends with Inspirations Ltd., Tortola (VG)

(72) Inventor: Ievgen Mashtakov, Warsaw (PL)

(21) Appl. No.: 14/846,970

(22) Filed: Sep. 7, 2015

Related U.S. Application Data
(60) Provisional application No. 62/184,833, filed on Jun. 25, 2015.

(51) Int. Cl. H04L 29/08

(52) U.S. Cl. CPC H04L 67/26; H04L 67/1097; H04L 67/20

(57) ABSTRACT

A system for real-time sharing of social experiences across multiple devices, comprising a social event manager that receives interaction from users via a network, wherein at least one of the plurality of users hosts a shared social event, a plurality of communication adapters each configured to facilitate communication between user devices and an event manager, a scheduling server that schedules events and notifies users of event scheduling, and a synchronization module that maintains synchronicity of media between participating users, and methods for sharing social experiences.

### CROSS-REFERENCE TO RELATED APPLICATIONS

This application claims the benefit of, and priority to, U.S. provisional patent applications Ser. No. 62/184,833, titled “SHARED EXPERIENCE AND MULTI-DEVICE HARDWARE PLATFORM” and filed on Jun. 25, 2015, the entire specification of which is incorporated herein by reference in its entirety.

### BACKGROUND OF THE INVENTION

Field of the Art

The disclosure relates to the field of social networking, and more particularly to the field of real-time sharing of social experiences.

Discussion of the State of the Art

In the art of social networking, it is common for users to share media content such as audio, video, or files for various purposes such as sharing a song or video they enjoyed, distribute presentation or lecture material, or to collaborate on documents. Users generally then view shared material on their own time and communicate with other users asynchronously, such as posting comments to a message board. There is currently no means for users to actively share and experience content in real-time with each other, viewing media and discussing with one another in a synchronous, real-time context in a manner similar to physically attending an event together.

What is needed is a means to facilitate real-time sharing of social events, wherein users may view media and actively participate with each other in real-time, communicating and contributing with other users during the course of the event.

### SUMMARY OF THE INVENTION

Accordingly, the inventor has conceived and reduced to practice, in a preferred embodiment of the invention, a system and methods for real-time sharing of social experiences across multiple devices.

According to a preferred embodiment, a system for real-time sharing of social experiences across multiple devices, comprising: a social event manager server comprising at least a plurality of programming instructions stored in a memory and operating on a processor of a network-connected computing device and configured to receive interaction from a plurality of users via a network, wherein at least one of the plurality of users hosts a shared social event; a plurality of communication adapters each comprising at least a plurality of programming instructions stored in a memory and operating on a processor of a network-connected computing device and configured to facilitate interaction between a social event manager server and a plurality of network-connected client devices; a scheduling server comprising at least a plurality of programming instructions stored in a memory and operating on a processor of a computing device and configured to maintain at least a time-based ordered list of social events received from a social event manager server, the ordered list comprising at least a plurality of social event trigger times, the trigger times corresponding to a time at which a social event is selected to begin, and to provide notification to a social event manager server when a social event trigger time becomes due; and a synchronization module comprising at least a plurality of programming instructions stored in a memory and operating on a processor of a computing device and configured to monitor participating network-connected devices in a shared social event, and to maintain synchronization of the social event across participating devices, is disclosed.

According to another preferred embodiment of the invention, a method for real-time sharing of social experiences across multiple devices, comprising the steps of configuring, at a social event manager server comprising at least a plurality of programming instructions stored in a memory and operating on a processor of a network-connected computing device and configured to receive interaction from a plurality of users via a network, wherein at least one of the plurality of users hosts a shared social event, a new social event; notifying, via plurality of communication adapters each comprising at least a plurality of programming instructions stored in a memory and operating on a processor of a network-connected computing device and configured to facilitate interaction between a social event manager server and a plurality of network-connected client devices, a plurality of users of the event; playing, using a synchronization module comprising at least a plurality of programming instructions stored in a memory and operating on a processor of a computing device and configured to monitor participating network-connected devices in a shared social event, and to maintain synchronization of the social event across participating devices, event media in a synchronized fashion to connected users; and ending the event, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for sharing real-time social experiences, according to a preferred embodiment of the invention.

FIG. 6 is a method flow diagram illustrating an exemplary method for operating shared real-time social experiences, according to a preferred embodiment of the invention.

FIG. 7 is an example of a shared-experience screen for multiple users to participate in an event.

FIG. 8 is an example of an event invitation.

FIG. 9 is an example of various user roles during a shared experience.

### DETAILED DESCRIPTION

Accordingly, the inventor has conceived and reduced to practice, in a preferred embodiment of the invention, a system and methods for real-time sharing of social experiences across multiple devices.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

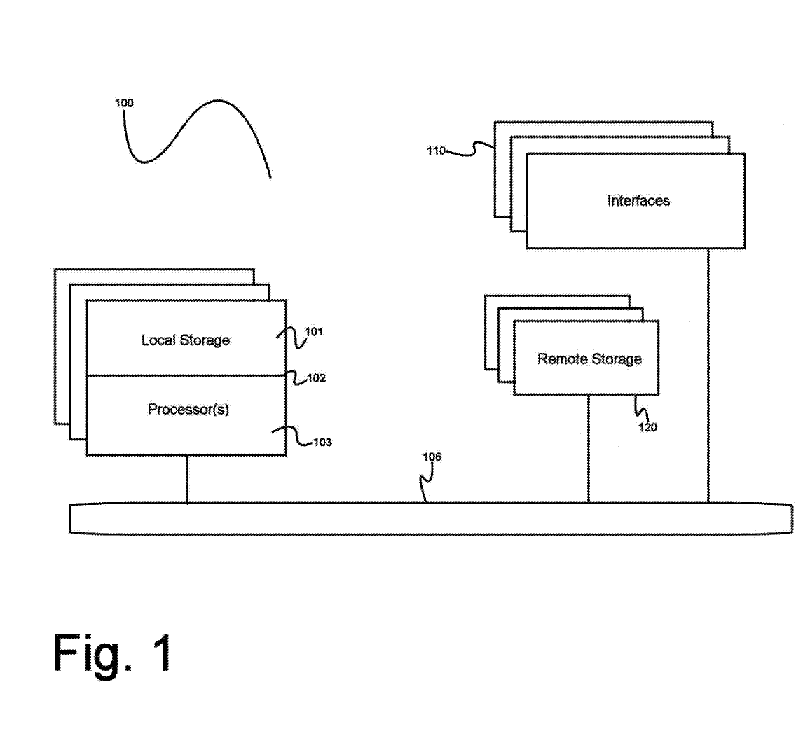

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

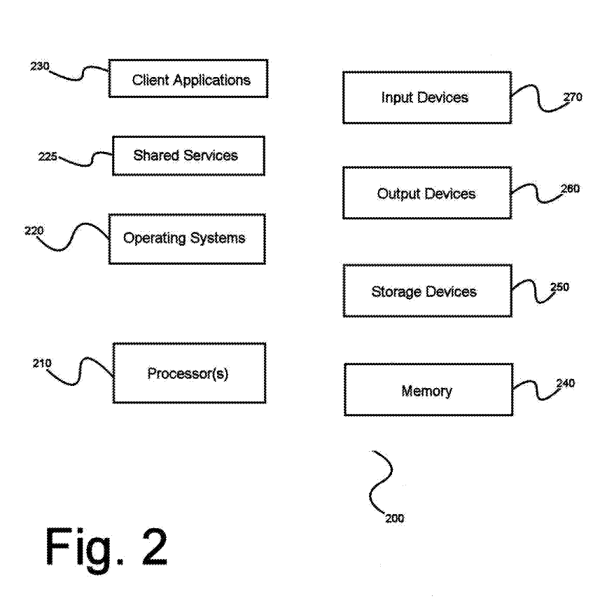

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

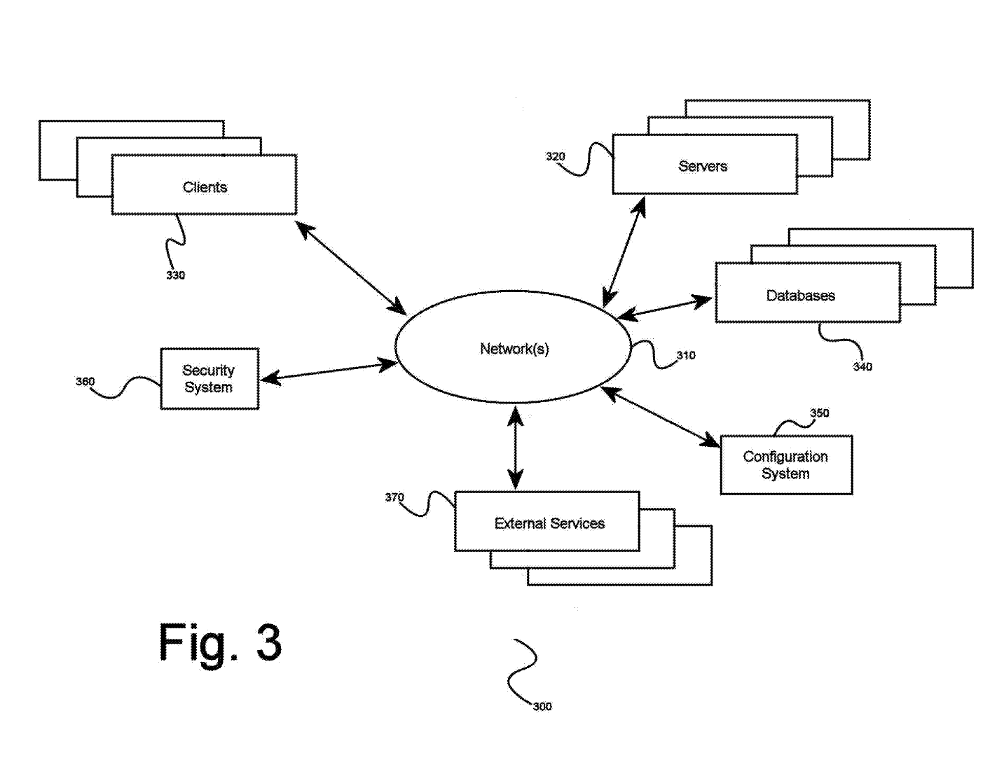

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

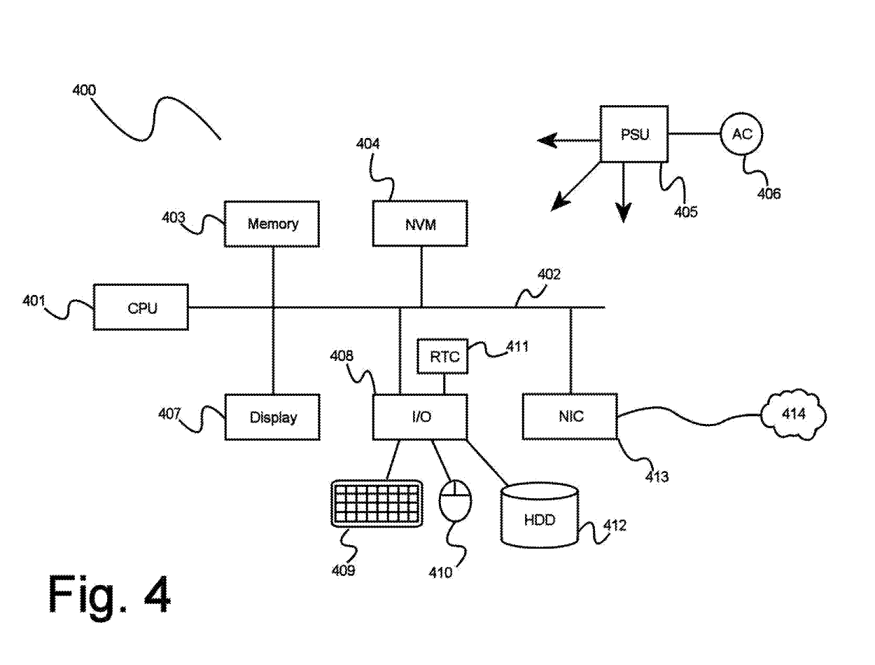

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

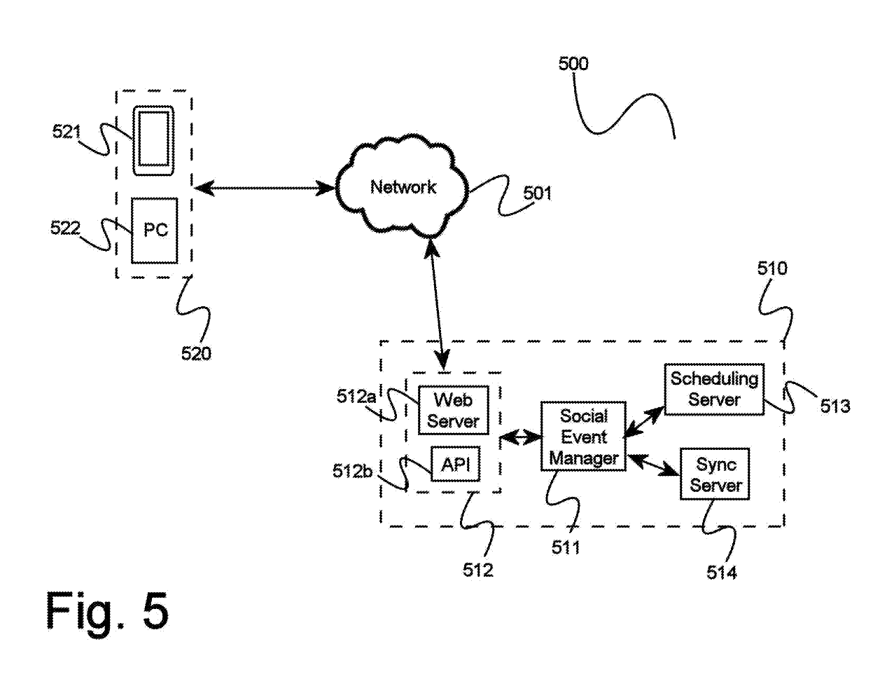

FIG. 5 is a block diagram of an exemplary system architecture 500 for sharing real-time social experiences according to a preferred embodiment of the invention. According to the embodiment, a social event sharing system 510 may comprise a social event manager server 511 comprising at least a plurality of programming instructions stored in a memory and operating on a processor of a network-connected computing device, that may be configured to receive interactions from a plurality of users via a network, for example via a plurality of user devices 520 such as a user's smartphone 521, personal computer 522, or other such network-connected computing devices. According to the embodiment, a user may host a social event, for example by configuring the details of an event for participation by other users, such as media file information (for example, including a video clip for participating users to watch), specific user information (such as specifying particular users that are allowed to participate, or are forbidden from participating), or scheduling information (for example, to setup a future-dated event to automatically begin at the scheduled time, without requiring further manual configuration at the scheduled time). Additional users may connect to event manager 511 to participate in an event, for example by using a configured software app on a smartphone 521 or accessing a web interface using a browser application on a personal computer 522, according to a particular arrangement. Additionally, event manager 511 may transmit event invitations to users, for example by using a plurality of communication adapters (described below) to send email, text message, or other notifications to a user device to alert a user that they have been invited to an event, or that a host they follow has a new event they are eligible to participate in. In this manner, invitations may be automatically sent to eligible users or they may be specifically sent to particular users, according to the nature of a particular event or a host user's preference. A host user may also specify contact information to be used for an event, such as an email address for users to send a message confirming participation or to ask question about an event, or a phone number or instant message address for users to communicate via text message or conference call.

Optionally, a host may choose to enable certain communication methods for participating users (such as text-based instant messages) without explicitly providing contact information for communication, and event manager 511 may automatically generate temporary communication information specific to an event (for example, a randomly-generated phone number for text messaging during an event, or a randomly-assigned instant message address for text-based chat between users). Relevant contact information may then be included in event invitations sent to users, so that they may be aware of any particular communication information beforehand if needed. According to the embodiment, such communication information may be used in place of, or in addition to, an integrated communication interface operated by an event manager 511, that may be available to users participating via particular means such as a web interface via a browser operating on a personal computer 522. In this manner, communication capability may be provided automatically for users and alternative communication methods may be provided for any users who may be unable to utilize an integrated communication functionality (for example, due to device constraints such as hardware or software capabilities, or security restrictions on a particular device such as a business device that may have particular capabilities blocked).

Further according to the embodiment, system 510 may comprise a plurality of communication adapters 512 each comprising at least a plurality of programming instructions stored in a memory and operating on a processor of a network-connected computing device and configured to facilitate interaction between a social event manager server and a plurality of network-connected client devices. For example, a web server 512a may operate an interactive web interface for users to communicate using a browser application on a personal computer 522, or a software application programming interface (API) 512b may facilitate embedded communication within a configured software application operating on a user's device. In this manner, users may be encouraged to use their own personal devices to host or participate in shared experiences.

Further according to the embodiment, communication adapters 512 may be used to facilitate cross-platform communication between users during an event, allowing user communication within an event regardless of the particular nature of a user's device. For example, users may be able to chat using a text-based interface within an event, that may be presented on-screen to users (for example, if participating via a web interface on a personal computer), and users may be able to provide text communication according to the nature of their particular device (for example, by typing on a computer keyboard, or by sending a text message on a smartphone to a specific number associated with an event, as may be configured by a host or automatically determined by an event manager 511), and all received communication may be displayed within the chat interface in a unified manner.

Further according to the embodiment, system 510 may comprise a scheduling server 513 comprising at least a plurality of programming instructions stored in a memory and operating on a processor of a computing device and configured to maintain at least a time-based ordered list of social events received from a social event manager server, the ordered list comprising at least a plurality of social event trigger times, the trigger times corresponding to a time at which a social event is selected to begin, and to provide notification to a social event manager server when a social event trigger time becomes due. For example, a host may configure a plurality of future-dated social events set to occur at specific times or on specific dates. Scheduling server 513 may maintain an ordered list of those scheduled events, and when an event becomes due (that is, when the current date or time correspond to those configured for the event) a notification is sent to event manager 511 to begin the event without host interaction at that particular time. In this manner, a host may configure a plurality of events to occur at specific dates or times, and need not be present for the events to continue as planned. Such functionality may be very useful for an event manager responsible for coordinating large numbers of events, or a user configuring events to occur in their absence, such as a blogger creating scheduled filler material to occur during a vacation, for example. Additionally, events may be triggered (that is, notification may be sent to begin the event without user interaction) if a scheduled time is determined to occur in the past, for example to prevent events from being skipped due to clock error (such as time zone or daylight savings time changes, for example).

Further according to the embodiment, system 510 may comprise a synchronization server 514 comprising at least a plurality of programming instructions stored in a memory and operating on a processor of a computing device and configured to monitor participating network-connected devices in a shared social event, and to maintain synchronization of the social event across participating devices. For example, event playback information may be provided by a user device 520 as part of network communication during an event, such as a device's local time and position in event media (such as a video being watched as part of an event, for example when multiple users want to watch a movie together). Such information may be used to determine a synchronization offset or other timing corrections, that may then be used to determine presentation of event content to that particular user (for example, streaming a video to one user at a time offset compared to another user, to account for individual network latency or other issues that may affect their playback position or rate) to ensure that all users remain in close synchronicity with one another during an event.

### Detailed Description of Exemplary Embodiments

“Shared experience” allows sharing of emotions and experienced content with other users in real-time. This allows users to share photos, watch video content, listen to audio, as well as comment, chat, or collaborate in real-time within the context of the content experience (for example, listening to a recording of a lecture and discussing the subject material during listening), without distracting from the experience or forcing users to switch applications or windows. A shared experience platform according to the invention provides an all-encompassing application interface for communication as well as content consumption or creation, where users may submit comments as well as files of various types within a unified interface.

The invention enables users to experience interactive entertainment with others in real-time, similar to in-person meetings or live events but recreated in a digital context. This allows users to connect in a more natural manner than generally possible electronically, and enables users to enjoy experiences that would normally require physical attendance (like a live concert, or a film in a theater), without being limited by physical distance or other constraints.

A user may send an invitation to an event (for example, watching a movie or listening to audio content) to other users. Invited users may be notified about an event, and given any pertinent details like date and time or participation expectations (for example, a professor might host an event for a class session and send an invite to students, informing them of the event time as well as minimum participation requirements for grading purposes). The host (that is, the user sending out the invitations) may manage the shared experience event, as is common with other electronic invitation arrangements in the art, such as FACEBOOK™ event invites or calendar events.

When a host (a user initiating an event to be shared with others) creates an event, data may be stored in an event database for providing to other users and devices as needed. From the perspective of a participating user's device, an automated software program (such as a script operating on their device) may periodically check for any new event data in an event database, and if an event is found a user may be notified (as may be appropriate on a user's personal device, for example a push notification on a smartphone) or an event may automatically begin (as may be appropriate for public use cases, such as an event on an electronic billboard or other public device where explicit user action is not required). Host and user devices may communicate via a network, to enable two-way interaction during an event such as to chat between users or comment on the event itself, or to interact with the event content such as for a host to pause a video playback or for users to annotate a shared document or image in a collaborative arrangement. By using a cloud-based arrangement as described below, event operation may be scalable to an arbitrarily large number of users as the resource demands on any particular user or device are kept to a minimum—that is, a user device may be required only to be capable of network communication and streaming any event content, while any heavy processing such as bulk data storage or media transcoding may be handled by server computers communicating via a network.

Users may be encouraged to participate in a shared experience according to a business-to-business (B2B) model, wherein software applications may be specifically configured to enable integration of a shared experience platform with various third-party products or services, for example to enable use on public transit or in venues like hotels or conference centers. Such an arrangement may be used to enable access to a shared experience platform for non-users, encouraging participation and enabling a variety of additional experience types such as “flash mobs” or anonymous group-based activities. A variety of hardware devices may be used according to the embodiments, for example including (but not limited to) a personal computer, server computer, mobile smartphone, tablet computing device, wearable computing device, or any other electronic device that may communicate via a network and present information to a user or receive interaction from a user. According to such an arrangement, all data may be stored in a cloud-based configuration to enable access from any network-connected device or service, without the constraints imposed by local storage. With cloud-based data storage, a host may have control over starting, interrupting, or otherwise configuring or controlling a shared event, by interacting with cloud-based data rather than data stored on a host or user's device (thereby ensuring user data is safely kept private from a host, for example).

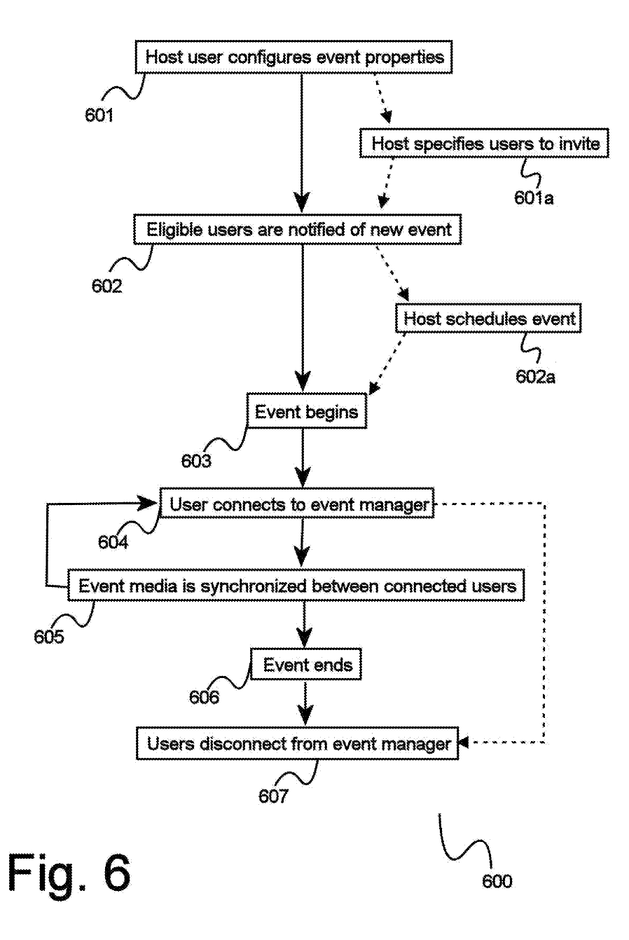

FIG. 6 is a method flow diagram illustrating an exemplary method 600 for operating shared real-time social experiences, according to a preferred embodiment of the invention. In an initial step 601, a host user may connect to an event manager and configure properties and data for an event such as, for example, audio or video media content, communication information, scheduling information, or specific user information (such as users to be allowed or blocked from participation). In an optional substep 601a, a host may configure a plurality of specific users to be invited to an event, for example to configure a closed participation event that only allows specified users to participate and blocks all others. In a next step 602, eligible users may be sent an invitation notification to inform them of an event, optionally based on any configured user or communication information from a previous step. In an optional step 602a, a host may configure scheduling information for an event, for example to specify a particular date and time when the event should begin. In a next step 603, the event may begin, optionally at a specified time from a previous step. In a next step 604, a user may connect to the event for participation, and event media may then be provided to the user in a next stem 605. Additional eligible users may continue to connect during an event in a looping fashion as shown, and event media may be provided to users in a synchronized manner so that new users may be up to speed and all users may be kept in close synchronicity with one another, ensuring that everyone may view the same media and preventing any users from being behind others (as may hamper user interaction and participation in an event, for example if users are discussing a video any users who are at a different point in the video would find it difficult to participate in discussion). In a next step 606, the event ends, optionally at a specified time or when all media is finished playing, or optionally when all users have disconnected (for example, according to a host's configuration, an event may continue even while no users are connected, or it may end automatically if all users leave during the event). In a final step 607 users may disconnect from the event manager. It should be appreciated that users may disconnect during an event as illustrated, but also that users may choose not to disconnect immediately after an event ends, for example if a video is finished playing but users are still discussing it, they may remain connected to an event manager and continue discussing the event through a provided communication interface, only leaving when they choose. Such behavior may be configured by a host or may be automatically-configured, such as using default values unless a host specifies alternate values such as, for example, “close this event immediately when media is finished” or, “allow users to remain connected up to X minutes after event ends”.

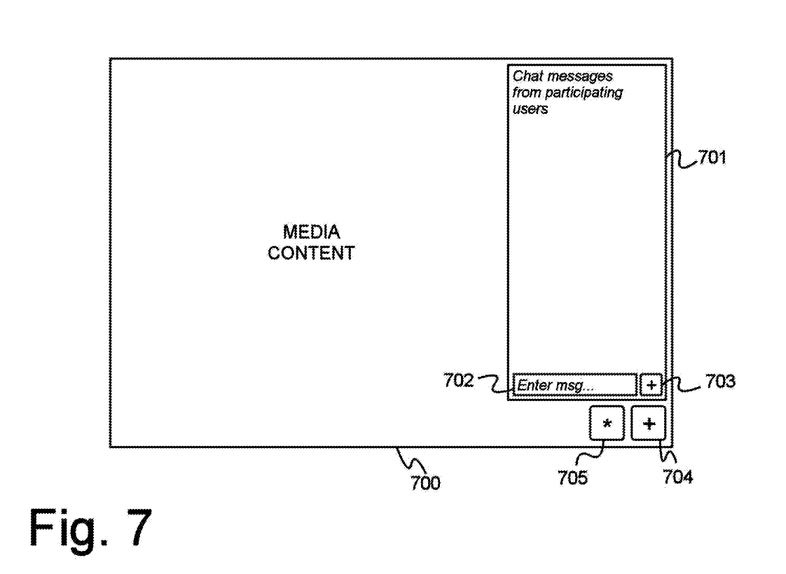

FIG. 7 is an example of a shared-experience screen 700 for multiple users to participate in an event. During an event, participating users may be presented with a display window (according to their particular device configuration, for example within a web interface on a personal computer, or software app on a smartphone, or other suitable device-specific display arrangement) comprising a display of event content such as audio or video media, presentation slides, or other content. A chat interface 701 may be displayed, showing user communication receive during an event and optionally providing a chat input 702 so that users may type directly into a chat interface 701 to participate in discussion. Users may also be given a button 703 or other interactive means to attach files to a message, for example to share a screenshot from a previous point in a video, or to share images or documents related to the event with other users. Users may also be given a button 705 to configure their particular display 700, such as to adjust volume of media playback (for example). According to a particular event configuration (for example, as configured by a host), users may be given an additional button 704 or other interactive means to invite additional users to participate in the event, for example by providing a phone number or email address to send an invitation.

In an exemplary audio-only event, a host may begin an event when they start playing music such as via a streaming media collection or a playlist. Event creation may be explicit (that is, the host manually specifies that they wish to start an event based on their audio listening), or implicit in nature (wherein a host doesn't perform any manual event actions, but when they begin listening an event is automatically created). Users may then join the event and they will join at the host's current position during playback (for example, partway through a song), as enforced by a synchronization server described previously (referring to FIG. 5). Users may be able to comment or discuss the audio using a chat interface as described above, and if a host pauses playback or selects different audio, those changes will be synchronized to all participating users. Optionally, a host may at any time choose to alter the media nature of the event, for example adding video content such as to stream content from a webcam or screen-capture software, for example to turn an audio-only event into a live streaming audio and video-based event (for example, to play a music playlist while streaming video of the host playing a videogame, or to play an audio lecture while streaming video of the host taking notes, or showing presentation slides).

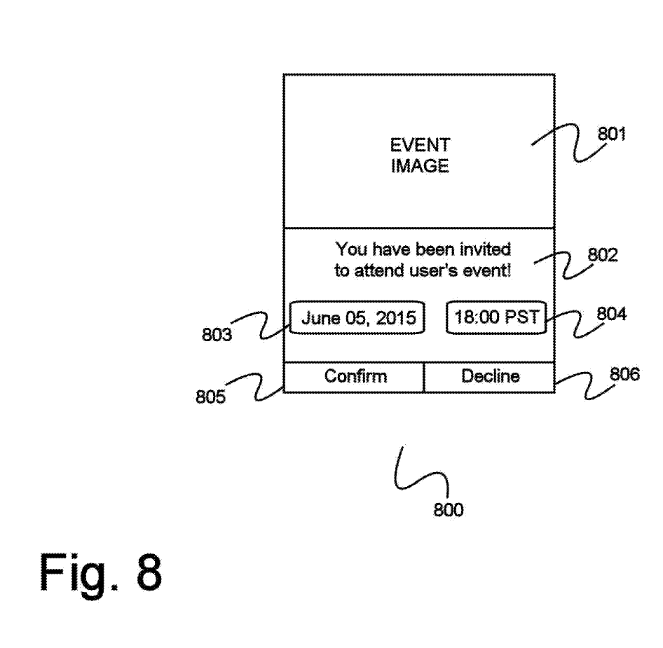

FIG. 8 is an example of an event invitation 800. If a user is eligible to participate in an event, for example by being specifically invited by a host (such as specifically or by being included in a list of eligible users during event configuration) or by fitting eligibility criteria such as following an event host on a social media network, they may be presented with an event invitation 800 when a host configures a new event (for example, via email or instant message, or via a push notification on a smartphone, or other various form of notification according to a user's particular device or preference). An invitation 800 may comprise an image 801 associated with an event, for example a still image captured from a video being presented during the event, or a summary of audio content (such as artist or album information, for example), or a snapshot of a document or presentation slide, or any other such image that may indicate or summarize the nature of an event. A message 802 may be included with an invitation 800, for example containing a text-based description or summary of an event, or a message from the host. If applicable (that is, if such specification was made by a host during event creation), an invitation 800 may contain information about a specific date 803 or time 804 when the event will be taking place, and a user may optionally be given interactive buttons or other means to either accept 805 or decline 806 an invitation, facilitating a convenient RSVP system to keep a host apprised of anticipated user participation.

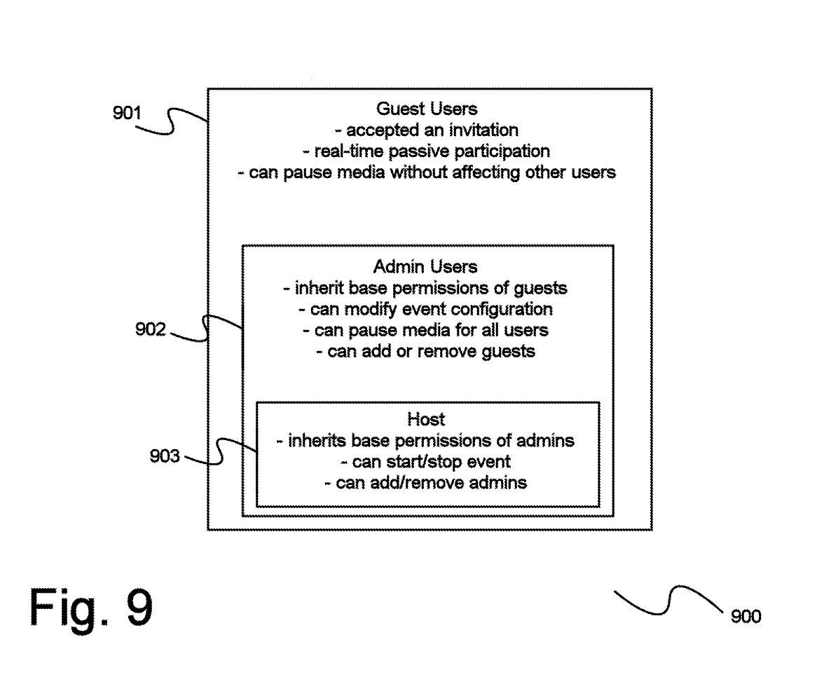

FIG. 9 is an example of various user roles during a shared experience. As illustrated, user roles may be used to easily specify permissions or abilities to be granted to users according to their role or user group, optionally using a nested arrangement to easily determine inheritance for permissions, making event configuration easier for a host. For example, a base or default user role may be a guest 901, which may define certain basic permissions such as the ability to view event media or communicate with other users through a chat interface. Guests may be permitted to pause media playback on their device without affecting other users (that is, when one guest pauses media it will continue playing for other users), and when they un-pause media they will resume at the current position of other participating users, rather than the position at which they paused (as may be enforced by a synchronization server, described above with reference to FIG. 5). A class of administrator users 902 may inherit the basic permissions of guests, along with additional privileges such as the ability to add or remove guest users (for example, removing disruptive users and optionally blocking them from re-joining an event), modifying event configuration (such as altering the time or duration of the event), or pausing media for all users, for example to pause a video for detailed discussion, and then later resuming from the position at which it was paused, as opposed to guest functionality described previously. A host user 903 may have effectively total control over an event, inheriting permissions from any and all other user roles as well as having the ability to start or stop the event itself, or alter user roles such as to select users to be given administrative privileges (for example, if a host has to leave the event and wishes to give another user admin rights to help facilitate the event in their absence). It should be appreciated that the roles and abilities described are exemplary, and may vary according to a particular event configuration (for example, a host may define additional user roles for an event).

The skilled person will be aware of a range of possible modifications of the various embodiments described above. Accordingly, the present invention is defined by the claims and their equivalents.

What is claimed is:

1. A system for real-time sharing of social experiences across multiple devices, comprising:
a social event manager server comprising at least a plurality of programming instructions stored in a memory and operating on a processor of a network-connected computing device and configured to receive interaction from a plurality of users via a network, wherein at least one of the plurality of users hosts a shared social event;
a plurality of communication adapters each comprising at least a plurality of programming instructions stored in a memory and operating on a processor of a network-connected computing device and configured to facilitate interaction between a social event manager server and a plurality of network-connected client devices;
a scheduling server comprising at least a plurality of programming instructions stored in a memory and operating on a processor of a computing device and configured to maintain at least a time-based ordered list of social events received from a social event manager server, the ordered list comprising at least a plurality of social event trigger times, the trigger times corresponding to a time at which a social event is selected to begin, and to provide notification to a social event manager server when a social event trigger time becomes due; and
a synchronization module comprising at least a plurality of programming instructions stored in a memory and operating on a processor of a computing device and configured to monitor participating network-connected devices in a shared social event, and to maintain synchronization of the social event across participating devices.

2. The system of claim 1, wherein the plurality of communication adapters comprise at least a web server.

3. The system of claim 1, wherein the plurality of communication adapters comprise at least a software API.

4. A method for real-time sharing of social experiences across multiple devices, comprising the steps of:
configuring, at a social event manager server comprising at least a plurality of programming instructions stored in a memory and operating on a processor of a network-connected computing device and configured to receive interaction from a plurality of users via a network, wherein at least one of the plurality of users hosts a shared social event, a new social event;
notifying, via plurality of communication adapters each comprising at least a plurality of programming instructions stored in a memory and operating on a processor of a network-connected computing device and configured to facilitate interaction between a social event manager server and a plurality of network-connected client devices, a plurality of users of the event;
playing, using a synchronization module comprising at least a plurality of programming instructions stored in a memory and operating on a processor of a computing device and configured to monitor participating network-connected devices in a shared social event, and to maintain synchronization of the social event across participating devices, event media in a synchronized fashion to connected users; and
ending the event.

5. The method of claim 4, further comprising the steps of:
scheduling, using a scheduling server comprising at least a plurality of programming instructions stored in a memory and operating on a processor of a computing device and configured to maintain at least a time-based ordered list of social events received from a social event manager server, the ordered list comprising at least a plurality of social event trigger times, the trigger times corresponding to a time at which a social event is selected to begin, and to provide notification to a social event manager server when a social event trigger time becomes due, a future-dated event;
notifying users of the event schedule; and
starting the event at a scheduled time.
